(19) United States
(12) Patent Application Publication
(10) Pub. No.: US 2018/0309584 A1
(43) Pub. Date: Oct. 25, 2018

(54) Data Service Charging Method, Apparutus, and System

(71) Applicant: Huawei Technologies Co., Ltd., Shenzhen (CN)

(72) Inventor: Xiaoqian Chai, Shenzhen (CN)

(21) Appl. No.: 16/024,195

(22) Filed: Jun. 29, 2018

Related U.S. Application Data
(63) Continuation of application No. PCT/CN2016/111340, filed on Dec. 21, 2016.

(30) Foreign Application Priority Data
Dec. 31, 2015 (CN) 201511028359.0
Mar. 25, 2016 (CN) 201610178261.1

(51) Int. Cl. H04L 12/14; H04L 29/08

(52) U.S. Cl. CPC H04L 12/1407; H04L 67/14; H04L 12/1414; H04L 12/1432

(57) ABSTRACT

A data service charging method, which is applied in a communications network of a policy and charging control (PCC) mechanism, and includes receiving, by an online charging system (OCS), a session setup request message from a gateway device, where the request message carries indication information indicating that the gateway device supports a charging session granularity of an Internet Protocol-connectivity access network (IP-CAN) session, and processing, by the OCS, the session setup request message according to the indication information and according to the charging session granularity of an IP-CAN session, and adding, to a response message to be returned to the gateway device, indication information indicating that the OCS performs charging according to the charging session granularity of an IP-CAN session.

### CROSS-REFERENCE TO RELATED APPLICATIONS

This application is a continuation of International Patent Application No. PCT/CN2016/111340 filed on Dec. 21, 2016, which claims priority to Chinese Patent Application No. 201610178261.1 filed on Mar. 25, 2016 and Chinese Patent Application No. 201511028359.0 filed on Dec. 31, 2015. The disclosures of the aforementioned applications are hereby incorporated by reference in their entireties.

### TECHNICAL FIELD

The present disclosure relates to the field of communications technologies, and in particular, to a data service charging method, an apparatus, and a system.

### BACKGROUND

Policy and Charging Control (PCC) is a set of PCC mechanisms defined by the 3rd Generation Partnership Project (3GPP). A PCC architecture is shown in FIG. 1. The architecture includes a policy and charging enforcement function (PCEF), a traffic detection function (TDF), a bearer binding and event reporting function (BBERF), a policy and charging rules function (PCRF), an application function (AF), an online charging system (OCS), an offline charging system (OFCS), and a subscription profile repository (SPR). In the architecture, there are interfaces such as Gx, Sy, Gy, and Ro (not shown). Gx is an interface between the PCRF and the PCEF, Sy is an interface between the PCRF and the OCS, Gy is an online charging interface between the PCEF and the OCS, and Ro is a generic name for an online charging interface between a network element and the OCS. The PCEF device is a policy and charging enforcement entity and used to execute a dynamic or static control policy, and may be located in a gateway device such as a general packet radio service (GPRS) support node (GGSN) or a packet data network (PDN) gateway (P-GW). The TDF is an application detection and control entity and used to execute an application detection and control policy delivered by the PCRF device. The PCRF device is a PCRF entity and responsible for control on, for example, quality of service (QoS), bandwidth, gate control, and a charging policy in a home network when user equipment uses a service. The SPR is a subscription data storage entity and used to store subscription data of a user. When mapped onto an existing system, the SPR may be an entity such as a home location register (HLR), a home subscriber server (HSS), or an OCS. In the mechanism, the PCRF entity performs policy decision, generates a data-stream-based charging policy and control policy for the PCEF entity, and generates an application detection and application control policy for the TDF entity. Then, the PCRF entity installs an application activation control policy for the TDF entity and installs a stream-based control and charging policy for the PCEF entity. The PCEF entity initiates, according to the data-stream-based charging policy delivered by the PCRF entity, a data-stream-based credit quota application request message, that is, a credit control request (CCR) message, to the OCS (if a bearer is being set up, the PCEF entity initiates a charging session setup request message to the OCS). The OCS performs quota authorization and returns the credit authorization to the PCEF entity.

The PCEF and the OCS set up a charging session using the Gy interface, that is, a Gy charging session is set up. In an evolved packet core (EPC) network, for a gateway, an interface between a serving gateway (S-GW) and a P-GW is an S5 interface, and the interface may use different mobility management protocols. When the S5 interface uses the GPRS tunneling protocol (GTP), the PCEF sets up a charging session for each Internet Protocol (IP)-connectivity access network (CAN) bearer (IP-CAN bearer) or sets up a charging session for each IP-CAN session. If the S5 interface uses the Proxy Mobile IP Protocol (PMIP), the PCEF sets up a charging session for each IP-CAN session.

As shown in FIG. 2A, one IP-CAN session may correspond to one or more charging sessions (each charging session corresponds to one bearer). In this case, one charging session corresponds to one IP-CAN bearer, that is, charging session per IP-CAN bearer. In short, a charging session granularity is an IP-CAN bearer granularity or a bearer granularity. As shown in FIG. 2B, one IP-CAN session corresponds to only one charging session. A charging session granularity is that one charging session corresponds to one IP-CAN session, that is, charging session per IP-CAN session. In short, a charging session granularity is an IP-CAN session granularity or a session granularity. The one charging session, as shown in FIG. 3, refers to a continuous process of a charging session between the PCEF and the OCS from sending a CCR initial (CCR-I) message, that is, an initial message of CCR request session setup to the OCS by the PCEF to sending a CCR termination (CCR-T) message, that is, a CCR request session termination message to the OCS by the PCEF. Each charging session has a unique session identifier (ID).

In other approaches, when a Gy interface is used for charging information transmission and processing, a charging session granularity of the Gy interface may be an IP-CAN session or an IP-CAN bearer. In actual deployment, it is likely that charging session granularities supported by a PCEF and an OCS/OFCS are different. In the case of two granularities, there is difference in a charging information collection mechanism, a charging information reporting occasion, or a charging information set. Therefore, if the two parties cannot agree on a charging session granularity, a charging processing error or inaccurate charging may occur.

### SUMMARY

Embodiments of the present disclosure provide a data service charging method, an apparatus, and a system. When different mobility management protocols at an S5 interface may result in two different charging session granularities between a gateway and a charging system, more accurate charging can be achieved using a mechanism of a charging session granularity negotiation between a gateway device and a charging device.

According to a first aspect, a data service charging method is provided and applied in a communications network of a PCC mechanism, and the method includes receiving, by an OCS, a session setup request message sent by a gateway device, where the request message carries a charging session granularity supported by the gateway device, and processing, by the OCS, the session setup request according to the charging session granularity.

According to a first implementation of the first aspect, when the charging session granularity is an IP-CAN session, processing, by the online system, the session setup request according to the charging session granularity includes rejecting the session setup request and returning an error code to the gateway device.

According to a second implementation of the first aspect, when the charging session granularity is an IP-CAN session, processing, by the online system, the session setup request according to the charging session granularity includes processing the session setup request message according to the charging session granularity of an IP-CAN session, and adding, to a response message to be returned to the gateway device, indication information indicating that the charging session is an IP-CAN session granularity charging session.

According to a first implementation of the second implementation of the first aspect, the session setup request message is a CCR-I message, and if there are multiple CCR-I messages, the OCS processes only a first received CCR-I message.

According to a first implementation of the first implementation of the second implementation of the first aspect, the OCS processes only the first received CCR-I message and rejects another CCR-I message, and adds, to a message returned for the rejected CCR-I message, a rejection cause indicating that the online charging session is already set up, or the IP-CAN session granularity charging session is used, or redirection to an IP-CAN session granularity charging session that is already set up is performed.

According to a first implementation of the first implementation of the first implementation of the second implementation of the first aspect, the OCS processes only the first received CCR-I message and rejects another CCR-I message, and adds, to a message returned for the rejected CCR-I, a rejection cause indicating that the online charging session is already set up, or an IP-CAN session granularity charging session is used, or redirection to an IP-CAN session granularity charging session that is already set up is performed.

According to the first implementation of the first implementation of the second implementation of the first aspect or according to the first implementation of the first implementation of the first implementation of the second implementation of the first aspect, the OCS allocates a quota for a quota application in the received multiple CCR-I messages, and returns, to the gateway device, the allocated quota in a charging session corresponding to the first CCR-I message.

According to a second aspect, a data service charging method is provided and applied in a communications network of a PCC mechanism, and the method includes sending, by a gateway device, a charging session setup request message of an IP-CAN bearer to an OCS, where the session setup request message carries indication information indicating that the gateway device supports a charging session granularity of an IP-CAN session, and receiving, by the gateway device, a response message that is returned by the OCS according to the charging session setup request.

According to a first implementation of the second aspect, the session setup request message is a CCR-I message, the response message returned to the gateway device is a credit control answer (CCA) initial (CCA-I) message, and the CCA-I message carries indication information indicating that the OCS performs charging according to the charging session granularity of an IP-CAN session.

According to a second implementation of the first implementation of the second aspect, the gateway device sends multiple CCR-I messages to the OCS, where the gateway device adds, to all the multiple CCR-I messages, the indication information indicating that the gateway device supports the charging session granularity of an IP-CAN session.

According to a third implementation of the second implementation of the first implementation of the second aspect, the gateway device sends multiple CCR-I messages to the OCS, where the gateway device adds, only to a first or default CCR-I message, the indication information indicating that the gateway device supports the charging session granularity of an IP-CAN session.

According to the third implementation of the second implementation of the first implementation of the second aspect, after the gateway device sends, to the OCS, the first CCR-I message carrying the indication information indicating that the gateway device supports the charging session granularity of an IP-CAN session, and the gateway device receives a CCA-I message that is returned by the charging system and carries the indication information indicating that the OCS performs charging according to the charging session granularity of an IP-CAN session, the gateway device binds, to a charging session corresponding to the first CCR-I message, all bearers of an IP-CAN session corresponding to the session setup request that require online charging, and performs, in the charging session, quota application and charging information reporting corresponding to all the bearers in the entire IP-CAN session.

According to a third aspect, a data service charging method is provided and applied in a communications network of a PCC mechanism, and the method includes sending, by a gateway device, a charging session setup request message of an IP-CAN session to an OCS, where the request message includes session granularity indication information in order to indicate that a charging session requested in the session setup request message is an IP-CAN session granularity charging session, and receiving, by the gateway device, a session setup success or failure message returned by the OCS.

According to a first implementation of the third aspect, the gateway device determines, according to a configuration of the gateway device or a PCRF instruction to initiate the charging session setup request of an IP-CAN session granularity.

According to a second implementation of the first implementation of the third aspect, if the gateway device receives the session setup failure message returned by the OCS, and determines, according to an error code carried in the failure message, that a charging session of an IP-CAN bearer granularity needs to be set up, the gateway device re-initiates a Gy charging session request of an IP-CAN bearer granularity for each IP-CAN bearer that requires online charging in the IP-CAN session.

According to a fourth aspect, a data service charging method is provided and applied in a communications network of a PCC mechanism, and the method includes receiving, by an OCS, a session setup request message sent by a gateway device, where the request message carries indication information indicating that the gateway device uses a charging session granularity of an IP-CAN session, and returning, by the OCS, a session setup success message to the gateway device.

According to a fifth aspect, a gateway device is provided and applied in a communications network of a PCC mechanism, and the gateway device includes a session granularity negotiation module, where the session granularity negotiation module is configured to send a session setup request message to an OCS, where the session setup request message carries indication information indicating that the gateway device supports a charging session granularity of an IP-CAN session, or carries indication information indicating that the gateway device uses a charging session granularity of an IP-CAN session to perform session charging, and the session granularity negotiation module is further configured to receive a response message returned by the OCS, where the response message carries indication information indicating that the charging system determines to perform session charging according to the charging session granularity of an IP-CAN session.

According to a sixth aspect, an OCS is provided and applied in a communications network of a PCC mechanism, and the OCS includes a session granularity negotiation module, where the session granularity negotiation module is configured to receive a session setup request message sent by a gateway device, where the session setup request message carries indication information indicating that the gateway device supports a charging session granularity of an IP-CAN session, or carries indication information indicating that the gateway device uses a charging session granularity of an IP-CAN session to perform session charging, and the session granularity negotiation module is further configured to return a response message to the gateway device, where when the session setup request message received by the OCS includes the indication information indicating that the gateway device supports the charging session granularity of an IP-CAN session, the response message returned by the session granularity negotiation module to the gateway device carries indication information indicating that the OCS determines to perform session charging according to the charging session granularity of an IP-CAN session.

According to a seventh aspect, a data service charging system is provided and applied in a communications network of a PCC mechanism, and includes a gateway device and an OCS, where the gateway device is configured to send a session setup request message to the OCS, where the session setup request message carries indication information indicating that the gateway device supports a charging session granularity of an IP-CAN session, or carries indication information indicating that the gateway device uses a charging session granularity of an IP-CAN session to perform session charging, the gateway device is further configured to receive a response message returned by the OCS, where the response message carries indication information indicating that the charging system determines to perform session charging according to the charging session granularity of an IP-CAN session, the OCS is configured to receive the session setup request message sent by the gateway device, where the session setup request message carries the indication information indicating that the gateway device supports the charging session granularity of an IP-CAN session, or carries the indication information indicating that the gateway device uses the charging session granularity of an IP-CAN session to perform session charging, and the OCS is further configured to return the response message to the gateway device, where when the session setup request message received by the OCS includes the indication information indicating that the gateway device supports the charging session granularity of an IP-CAN session, the response message to be returned by the OCS to the gateway device carries the indication information indicating that the charging system determines to perform session charging according to the charging session granularity of an IP-CAN session.

According to an eighth aspect, a data service charging system is provided and applied in a communications network of a PCC mechanism, and the service charging system includes a gateway device and an OFCS, where charging information reported by the gateway device reports to the OFCS includes a charging granularity of the gateway device, and the charging granularity is an IP-CAN session charging granularity, and the OFCS is configured to process the charging information that is reported by the gateway device and that includes the charging granularity of an IP-CAN session.

According to all the foregoing aspects, the gateway device may determine, according to the configuration of the gateway device, such as a charging characteristic configuration, a charging session granularity that can be supported or that needs to be set up. Alternatively, a PCRF device in a gateway device home domain or visited domain can determine a charging session granularity to be initiated by the gateway device PCEF, and deliver the charging session granularity to the gateway device PCEF using a PCC rule, and the PCEF determines, according to the PCC rule, a Gy interface charging session granularity, and initiates a negotiation with an OCS. In this manner, the gateway device PCEF can be prevented from simultaneously reporting multiple Gy CCRs to the OCS.

An embodiment of the present disclosure further provides a computer readable storage medium configured to store a computer software instruction used by the foregoing device or system, and a computer program is configured to perform the foregoing methods.

Another aspect of this application provides a computer program product, and when the computer product is executed, the computer product is used to perform the methods according to the foregoing aspects.

It may be learned from the foregoing solutions in the embodiments of the present disclosure that, According to the present disclosure, in case the OCS simultaneously supports two charging session granularities, when setting up a charging session, the gateway device and the OCS negotiate a session granularity, and set up the charging session between the gateway device and the OCS according to the negotiated granularity, or if the OFCS may simultaneously support two charging session granularities, when charging information is being reported, a granularity of the reported charging information is indicated such that the charging system processes a call detail record (CDR) according to the indication information, thereby improving charging accuracy.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a logical structural diagram of a PCC system;

FIG. 2A is a schematic diagram of a case in which a charging session granularity is an IP-CAN bearer;

FIG. 2B is a schematic diagram of a case in which a charging session granularity is an IP-CAN session;

FIG. 3 is a schematic diagram of one charging session process between a PCEF and an OCS;

FIG. 4 is a schematic diagram of a data service charging system architecture according to an embodiment of the present disclosure;

FIG. 5 is a schematic diagram of a method for determining a charging session granularity by an OCS according to an embodiment of the present disclosure;

FIG. 6 is a schematic diagram of a method for determining a charging session granularity by a PCEF according to an embodiment of the present disclosure;

FIG. 7 is a schematic structural diagram of a gateway device according to an embodiment of the present disclosure; and

FIG. 8 is a schematic structural diagram of a charging system according to an embodiment of the present disclosure.

### DESCRIPTION OF EMBODIMENTS

The technical solutions in the embodiments of the present disclosure are clearly described in the following with reference to the accompanying drawings.

A charging system in the present disclosure includes an OCS or an OFCS.

A gateway device in the present disclosure is a gateway at a network layer, including but not limited to, a GGSN, a P-GW, or the like. The gateway device includes a PCEF entity. In the embodiments of the present disclosure, an entity may also be described as a device. Each entity may be a separate device, or may be a device that is disposed in another device. For example, a PCRF entity may be a PCRF device. A charging trigger function (CTF) is usually embedded in a network entity. For example, the PCEF may be used as the CTF and embedded in a P-GW.

According to a main idea of the present disclosure, in online charging, if the CTF may simultaneously support two charging session granularities, when setting up a charging session, the gateway device and the OCS negotiate a session granularity, and set up the charging session between the gateway device and the OCS according to the negotiated granularity, and in offline charging, if the CTF may simultaneously support two charging session granularities, when charging information is being reported, a granularity of the reported charging information is indicated such that the OFCS processes a CDR according to an indication information.

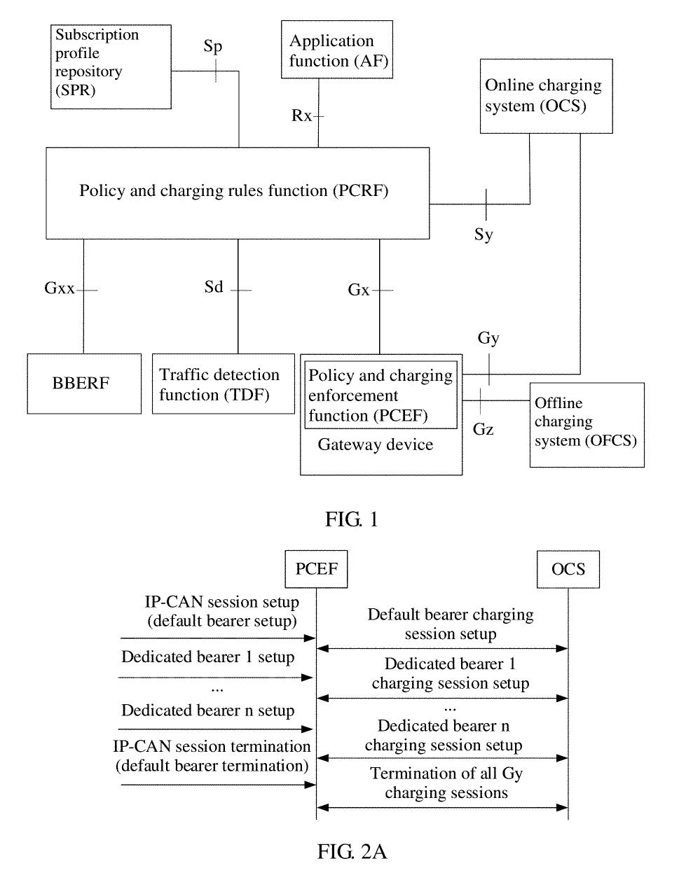

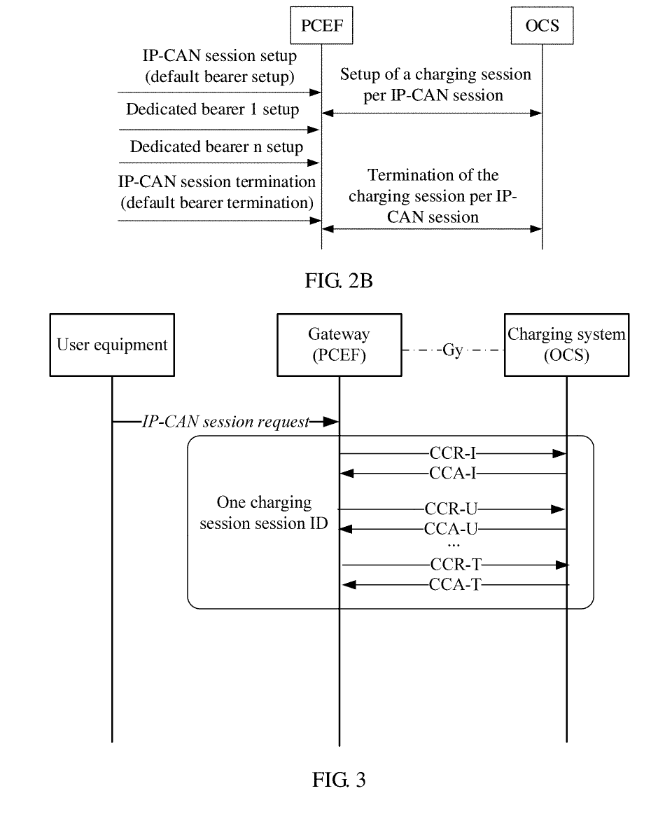

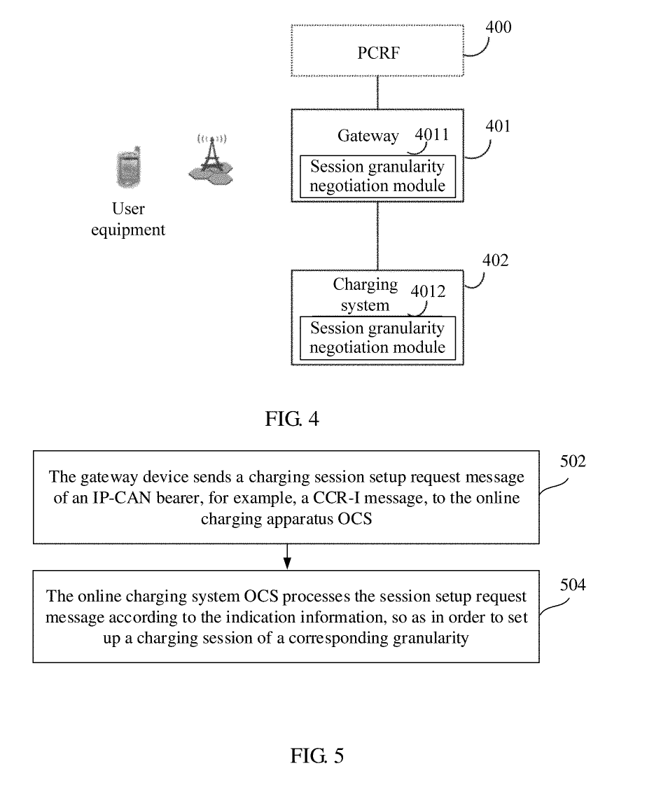

The embodiments of the present disclosure may be implemented based on a PCC architecture shown in FIG. 1. For actual networking, refer to FIG. 4. FIG. 4 is a schematic diagram of an actual network architecture according to an embodiment of the present disclosure. Network elements that are improved in this embodiment of the present disclosure mainly include a gateway 401 (including a PCEF function) and a charging system 402 (including an OCS function). The gateway 401 and the charging system 402 include corresponding session granularity negotiation modules 4011 and 4012, respectively.

Further, the session granularity negotiation module 4011 in the gateway 401 is configured to send a session setup request message, that is, a CCR message, to the charging system 402. The CCR message carries indication information indicating that the gateway 401 supports a charging session granularity of an IP-CAN session, or carries indication information indicating that the gateway 401 uses a charging session granularity of an IP-CAN session to perform session charging. The session granularity negotiation module 4011 may be further configured to receive a response message returned by the charging system 402. The response message carries indication information indicating that the charging system 402 determines to perform session charging according to the charging session granularity of an IP-CAN session.

The session granularity negotiation module 4012 in the charging system 402 is configured to receive the session setup request message, that is the CCR message, sent by the gateway 401. The CCR message carries the indication information indicating that the gateway 401 supports the charging session granularity of an IP-CAN session, or carries the indication information indicating that the gateway 401 uses the charging session granularity of an IP-CAN session to perform session charging. The session granularity negotiation module 4012 is further configured to return the response message to the gateway 401. When the CCR message received by the charging system 402 includes the indication information indicating that the gateway 401 supports the charging session granularity of an IP-CAN session, the response message returned to the gateway 401 may carry the indication information indicating that the charging system 402 determines to perform session charging according to the charging session granularity of an IP-CAN session.

According to the gateway and the charging system in the embodiments of the present disclosure, when setting up a charging session, the gateway and the charging system can negotiate a charging session granularity, and set up the charging session between the gateway and the charging system according to the negotiated granularity, thereby avoiding inconsistent processing of charging information in the case of two granularities, and improving charging accuracy and charging efficiency.

The following uses online charging as an example to illustrate a solution of an embodiment of the present disclosure. In this embodiment, a gateway device (including a PCEF function) reports a supported charging session granularity capability, and an OCS determines a charging session granularity. A gateway 401 and a charging system 402 shown in FIG. 4 may be configured to implement a method in this embodiment of the present disclosure.

In this embodiment, the gateway device may set up multiple IP-CAN bearers for one IP-CAN session, each IP-CAN bearer corresponds to one session setup request message, which may also be referred to as a CCR-initial message, that is, a CCR-I message. Therefore, a PCEF may simultaneously report multiple CCR-I messages to the OCS. In this case, refer to a schematic method flowchart shown in FIG. 5 according to an embodiment of the present disclosure. A specific method procedure is described as follows.

First, the gateway device receives an IP-CAN session setup request sent by user equipment UE. After the gateway device determines, according to a PCC rule delivered by a PCRF, an IP-CAN bearer to be set up, the gateway device performs the following steps.

Step 502: The gateway device sends a charging session setup request message of an IP-CAN bearer, for example, a CCR-I message, to the online charging apparatus OCS, where the session setup request message carries indication information of a charging session granularity supported by the gateway device, for example, a granularity of an IP-CAN session.

Further, the gateway device sends the CCR-I message to the OCS for each IP-CAN bearer in order to set up a Gy interface charging session and to request authorization. The gateway device uses, for example, a session granularity negotiation module 4011 in FIG. 4, to add a parameter to the CCR-I message to indicate that the PCEF can support an IP-CAN session granularity Gy session, for example, a parameter A. The gateway device adds the parameter A to the to-be-sent Gy CCR-I request to indicate that the gateway device supports an IP-CAN session granularity charging session.

Specific methods for adding the parameter A to the CCR message by the gateway device PCEF may be as follows.

Method 1: The parameter A is added to a first CCR-I message. The OCS sets up, according to the parameter A carried in the first CCR-I message, a Gy session corresponding to the first CCR-I message, uses the Gy session as a Gy session of the IP-CAN session, and adds a parameter B to a CCA-I message that is returned to the gateway device and corresponds to the CCR-I message to indicate, to the gateway device, that the current Gy session is used as the Gy session of the IP-CAN session. In this way, the gateway device binds, to the Gy session according to the parameter B, all bearers of the IP-CAN session that require online charging, and performs, in the session, quota application and charging information reporting corresponding to all the bearers in the entire IP-CAN session. The OCS rejects a subsequently received CCR-I request, and adds a rejection cause to a CCA-I message that is to be returned to the gateway device and corresponds to the CCR-I message. Preferably, the CCA-I message corresponding to the first CCR-I message is first returned to the gateway device. Preferably, if the gateway device simultaneously sends a CCR-I message of a default bearer and a CCR-I message of a dedicated bearer, the CCR-I message corresponding to the default bearer is considered as the first CCR-I message, the parameter A is added to the Gy CCR-I message of the default bearer, and the PCEF further adds a packet data protocol (PDP) context type to the CCR-I message to indicate whether a current request corresponds to the default bearer.

Method 2: The parameter A is added to all CCR-I messages to be sent. The OCS receives, according to the parameter A, a first Gy CCR-I request, sets up a Gy session corresponding to the first CCR-I message, uses the Gy session as a Gy session of the IP-CAN session, and adds a parameter B to a CCA-I message that is returned to the gateway device and corresponds to the CCR-I message, to indicate, to the gateway device, that the current Gy session is used as the Gy session of the IP-CAN session. In this way, the gateway device binds, to the Gy session according to the parameter B, all bearers of the IP-CAN session that require online charging, and performs, in the session, quota application and charging information reporting corresponding to all the bearers in the entire IP-CAN session. The OCS rejects a subsequently received CCR-I request, and adds a rejection cause to a CCA-I message that is to be returned to the gateway device and corresponds to the CCR-I message. Preferably, the CCA-I message corresponding to the first CCR-I message is first returned to the gateway device. Preferably, if the gateway device simultaneously sends a CCR-I message of a default bearer and a CCR-I message of a dedicated bearer, the OCS considers the CCR-I message corresponding to the default bearer as the first CCR-I message, accepts a Gy CCR-I request of the default bearer according to the parameter A to set up a Gy session corresponding to the default bearer, uses the Gy session corresponding to the default bearer as a Gy session of the IP-CAN session, and rejects a CCR-I request of the dedicated (or referred to as dedicated) bearer. The PCEF adds a PDP context type to the CCR-I message to indicate whether the current session is for the default bearer. Each IP-CAN session has only one default bearer. A difference between the dedicated bearer and the default bearer lies in QoS and priorities.

Method 3: The gateway device PCEF first sends only one Gy CCR-I message, which carries the parameters A to indicate that the gateway device supports a session granularity. The OCS performs determining according to the parameter A, and if the OCS determines to use the session granularity this time, the OCS adds a parameter B to a CCA-I message to be returned to the gateway device to indicate, to the gateway device, that the current Gy session is used as a Gy session of the IP-CAN session. The gateway device binds, to the Gy session according to the parameter B, all bearers of the IP-CAN session that require online charging, and performs, in the session, quota application and charging information reporting corresponding to all the bearers in the entire IP-CAN session. If the OCS determines not to use the session granularity this time, the OCS does not indicate, in a CCA-I message returned to the gateway device, to the gateway device, that the current Gy session is used as a granularity of the IP-CAN session, and after receiving the CCA-I message, the gateway device uses the Gy session only as a Gy session of a corresponding bearer, and initiates a Gy session setup request (CCR-I) for another bearer that requires online charging. The parameter A is not added to all CCR-I messages sent this time. If the OCS cannot identify the parameter A, the OCS directly rejects the CCR-I message and returns an error code to the gateway device. After receiving the CCA-I message, the gateway device initiates a Gy session setup request (CCR-I) according to the error code for all bearers (including a current bearer) that require online charging. The parameter A is not added to all CCR-I messages sent this time. Preferably, if the gateway device determines that an online charging session needs to be set up for a default bearer and a dedicated bearer at the same time, only a Gy CCR-I message corresponding to the default bearer is sent for the first time. According to Method 3, the OCS can avoid complex processing.

Further, capability indication information, carried in the CCR-I message, of supporting a session charging session granularity may be shown in the following example:

```
<CCR>
  [Service-Information]
    [PS-Information]
        [PS-Information-Level]//Parameter A
```

The parameter A indicates the gateway device supports the charging session granularity of an IP-CAN session. If there is no parameter A, the charging session granularity is an IP-CAN bearer by default.

Step 504: The OCS processes the session setup request message according to the indication information in order to set up a charging session of a corresponding granularity.

The OCS processes the session setup request message according to the indication information includes that the OCS learns, according to the indication information, that a capability of the gateway device supports an IP-CAN session granularity charging session, and further determines a granularity of the charging session this time according to a capability of the OCS and a decision mechanism. A specific process is as follows.

If a charging session granularity this time is an IP-CAN session granularity charging session, the OCS performs processing according to the charging session of an IP-CAN session granularity, and adds a parameter B to a CCA-I message to be returned to the gateway device to indicate that the Gy charging session is used as the charging session of an IP-CAN session granularity. For example, a response message is returned to a gateway 401 using a session granularity negotiation module 4012 in a charging system in FIG. 4, and the response message returned to the gateway 401 carries indication information indicating that a charging system 402 determines to perform charging according to the charging session granularity of an IP-CAN session.

A specific example method in which the parameter B is added to the CCA-I message is as follows:

```
<CCA>
  [Service-Information]
    [PS-Information]
        [PS-Information-Level]//Parameter B
```

The parameter B indicates that the OCS determines to use a charging session of an IP-CAN session granularity. If there is no parameter B, the OCS uses the charging session granularity of an IP-CAN bearer by default.

If the OCS cannot identify the parameter A, the OCS ignores the parameter A and performs processing according to a granularity of an IP-CAN bearer. Alternatively, if the OCS cannot identify the parameter A, the OCS rejects the CCR-I request and returns an error code to the PCEF to indicate that the parameter cannot be identified. Alternatively, although the parameter A can be identified, if the capability of the OCS does not support a session granularity charging session, or although the capability of the OCS supports a session granularity charging session, if the OCS determines not to use a session granularity charging session according to an internal policy of the OCS or a subscription relationship of a user, the OCS ignores the parameter A, and performs processing according to a bearer granularity Gy session.

Further, if the OCS simultaneously receives multiple Gy session CCR-I messages (greater than or equal to 2 messages) of a same IP-CAN session that are sent by the gateway device and determines that an IP-CAN session granularity charging session is to be set up, the OCS rejects another CCR-I message, and the gateway device associates another bearer with the Gy session that is set up. Alternatively, if the OCS simultaneously receives multiple Gy session CCR-I messages, the OCS rejects another CCR-I message and indicates, in a CCA message, a redirection to a Gy session that is set up (carrying a destination Gy session ID), and the gateway device associates the bearer with a Gy session corresponding to the session ID.

Further, if the gateway device has not received the CCA after the OCS returns the CCA, the gateway device initiates a new CCR-I request. If the OCS determines that a session granularity charging session is to be set up, and a session granularity Gy session is already set up, the OCS rejects the CCR-I charging session request, and optionally, indicates, in a CCA message, a redirection to the Gy session that is set up (carrying the destination Gy session ID).

Further, if the OCS simultaneously receives multiple Gy CCR-I messages, the OCS first processes a Gy CCR-I message corresponding to a default session.

Further, that the OCS performs processing according to the session granularity Gy includes that the OCS allocates a quota for a quota application in the received multiple CCR-I messages, returns the allocated quota to the gateway device in a CCA-I message of the session granularity Gy session to be set up, and rejects another CCR-I request in a CCA-I message corresponding to the other CCR-I message.

In the solution in this embodiment of the present disclosure, indication information indicating that the gateway device supports a charging session granularity of an IP-CAN session is added to a session request message sent by the gateway device to the OCS such that the OCS can learn of a support status of the gateway device for the charging session granularity and perform corresponding processing. If the OCS determines, according to the indication information, to process the charging session according to the charging session granularity of an IP-CAN session, the OCS adds, to a response message to be returned to the gateway device, indication information indicating that the OCS performs charging according to the charging session granularity of an IP-CAN session. Therefore, when setting up a charging session, the gateway device and the OCS can negotiate a charging session granularity, and set up the charging session between the gateway device and the OCS according to the negotiated granularity, thereby avoiding inconsistent processing of charging information in the case of two granularities, and improving charging accuracy and charging efficiency. In this embodiment, the OCS determines a to-be-used charging session granularity according to a charging session granularity support status reported by the gateway device, thereby alleviating decision burden on the PCRF.

The following continues to use online charging as an example to illustrate an implementation solution of determining a Gy interface charging session granularity by a gateway device (including a PCEF function). A gateway 401 and a charging system 402 shown in FIG. 4 may be configured to implement a method of an embodiment of the present disclosure.

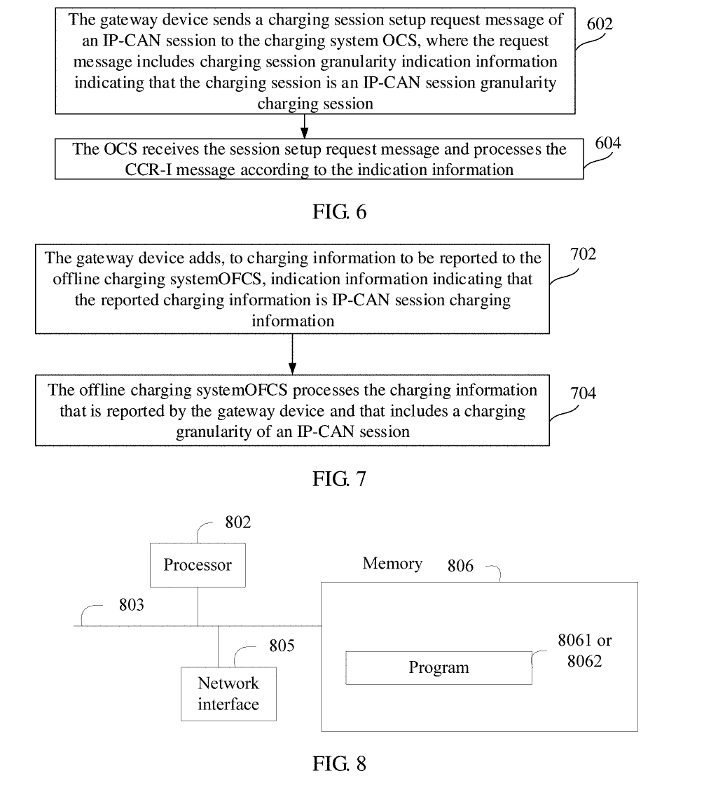

In this embodiment, a gateway device determines the Gy charging session granularity, and when determining that only one Gy charging session is set up for one IP-CAN session, the gateway device may initiate only one Gy CCR-I message to an OCS, thereby avoiding simultaneously reporting multiple Gy CCR-I request messages. Referring to a flowchart shown in FIG. 6, a specific method is described as follows.

Step 602: The gateway device sends a charging session setup request message of an IP-CAN session to the charging system OCS, where the request message includes charging session granularity indication information indicating that the charging session is an IP-CAN session granularity charging session.

Further, the PCEF determines, according to a configuration of the PCEF or a PCRF instruction, to set up a session granularity Gy for the IP-CAN session and initiates a Gy session setup request to the OCS. The CCR-I request uses a specific Attribute-Value Pair (AVP) to indicate that the current CCR-I message is a request message of the session granularity charging session. A carried parameter corresponds to the session granularity charging session, and a requested quota may be used for multiple bearers.

The gateway device may determine, according to a configuration of the gateway device, such as a charging characteristic configuration, a granularity of a charging session that needs to be set up. Alternatively, a PCRF (for example, a PCRF 400 shown in FIG. 4) in a home domain or a visited domain determines a granularity of a charging session initiated by the gateway device PCEF and delivers the granularity of the charging session to the gateway device PCEF using a PCC rule. The PCEF determines the Gy interface charging session granularity according to the PCC rule.

Step 604: The OCS receives the session setup request message and processes the CCR-I message according to the indication information.

Further, if the OCS agrees to use the session granularity charging session, the OCS normally processes the session setup request message CCR-I, and returns a session setup success message.

If the OCS does not support the charging session granularity indication information, or the OCS supports the charging session granularity indication information but does not accept setup of a session granularity charging session according to the configuration, the OCS rejects the charging session request and returns an error code indicating that identification fails or a session granularity Gy session cannot be set up.

After receiving a failure response message from the OCS, the gateway device determines, according to an error code carried in a CCA-I message, that a bearer granularity charging session needs to be set up, and re-initiates a Gy charging session request of the bearer granularity for each IP-CAN bearer in the IP-CAN session.

In the solution in this embodiment of the present disclosure, indication information indicating that the gateway device uses a charging session granularity of an IP-CAN session to perform session charging is added to a session request message sent by the gateway device to the OCS such that the OCS can learn of a charging session granularity that the gateway device determines to use, and performs corresponding processing according to the indication information. Therefore, when setting up a charging session, the gateway device and the OCS can negotiate a charging session granularity, and set up the charging session between the gateway device and the OCS according to the negotiated granularity, thereby avoiding inconsistent processing of charging information in the case of two granularities, and improving charging accuracy and charging efficiency. Further, in the solution, the gateway device PCEF determines a to-be-used charging session granularity, thereby enhancing autonomy of the gateway device PCEF, and alleviating burden on the OCS.

An embodiment of the present disclosure further provides an implementation solution of determining a charging information collection granularity by a gateway device PCEF in the case of offline charging (OFCS). A method flowchart is shown in FIG. 7. This embodiment may be implemented if a charging system 402 in FIG. 4 is an OFCS.

Step 702: The gateway device adds, to charging information to be reported to the OFCS, indication information indicating that the reported charging information is IP-CAN session charging information.

Further, if an accounting request (ACR) message is used for charging information reporting, a parameter C is added to an ACR report command to indicate that the reported charging information is IP-CAN session granularity charging information or IP-CAN bearer granularity charging information. If the parameter does not exist, the charging information is the IP-CAN bearer granularity charging information by default. After receiving the ACR message that carries the parameter and is sent by the PCEF, a Charging Data Function (CDF) module generates a CDR according to the indication information, and adds a parameter D with a same function to the CDR. In this way, when processing the CDR, the charging system determines, according to the field, that information in the CDR is the IP-CAN session granularity charging information or the IP-CAN bearer granularity charging information, and performs correct CDR processing, for example, deduplication, merge, association, or rating.

If the PCEF directly generates a CDR, a parameter D with a same function is added to the generated CDR to indicate that the reported charging information is the IP-CAN session charging information or the IP-CAN bearer charging information. Alternatively, if the parameter does not exist, the charging information is the IP-CAN bearer charging information by default. In this way, when processing the CDR, the charging system determines, according to the field, that information in the CDR is the IP-CAN session charging information or the IP-CAN bearer charging information, and performs correct CDR processing, for example, deduplication, merge, association, or rating.

A specific example method in which the parameter C is added to the ACR command is as follows:

```
<ACR>
  [Service-Information]
    [PS-Information]
        [PS-Information-Level]//Parameter C
```

The parameter D added to the CDR is as follows:

| | | |
|---|---|---|
| CDR Level | OC | The parameter indicates that reported charging |
| | | information is IP-CAN session granularity |
| | | charging information or IP-CAN bearer granularity |
| | | charging information. Alternatively, if the |
| | | parameter does not exist, charging information is |
| | | IP-CAN bearer granularity charging information by |
| | | default. |

Step 704: The OFCS processes the charging information that is reported by the gateway device and that includes a charging granularity of an IP-CAN session.

Further, when processing a CDR, the OFCS, for example, the charging system 402 in FIG. 4 (which is an OFCS in this case) determines, according to the field added to the charging information in step 702, that is, according to a charging granularity information ID field, that information in the CDR is the IP-CAN session granularity charging information, and performs further processing. Certainly, if the added field is empty, the charging information is the IP-CAN bearer granularity charging information by default.

The gateway device may determine, according to a configuration of the gateway device, such as a charging characteristic configuration, a charging session granularity (which is the IP-CAN session granularity charging information or the IP-CAN bearer granularity charging information) to be reported. Alternatively, a PCRF (such as a PCRF 400 in FIG. 4) in a home domain or a visited domain determines the charging session granularity reported by the PCEF.

In this embodiment, if the OFCS may simultaneously support two charging granularities, when charging information is being reported, a granularity of the reported charging information is indicated. The OFCS processes a CDR according to the indication information, thereby ensuring charging accuracy and improving charging efficiency.

FIG. 8 shows a structure of a gateway device (including a PCEF function) according to another embodiment of the present disclosure. The gateway device may be configured to perform the steps in all the foregoing described method embodiments. The gateway device may be a gateway 401 in FIG. 4, including at least one processor 802 (for example, a central processing unit (CPU)), at least one network interface 805 or another communications interface, a memory 806, and at least one communications bus 803 used for connection and communication between these apparatuses. The processor 802 is configured to execute an executable module, such as computer program, stored in the memory 806. The memory 806 may include a high-speed random access memory (RAM), or may further include a non-volatile memory, such as at least one magnetic disk storage. Communicative connection between the gateway device and at least one another network element is implemented using at least one network interface 805 (which may be a wired or wireless interface), and the Internet, a wide area network, a local area network, a metropolitan area network, and the like may be used.

This embodiment of the present disclosure further provides a computer program product and a storage medium that stores the foregoing computer program. The computer program product includes program code stored in a computer readable storage medium, and the program code is loaded using the processor to implement the foregoing method. In some implementations, the memory 806 stores a program 8061, and the program 8061 may be executed by the processor 802. This program includes sending, by the gateway device, a session setup request message to an OCS, where the session setup request message carries indication information indicating that the gateway device supports a charging session granularity of an IP-CAN session, and receiving, by the gateway device, a response message returned by the OCS, where the response message carries indication information indicating that the OCS performs charging according to the charging session granularity of an IP-CAN session.

Alternatively, the program includes sending, by the gateway device, a session setup request message to an OCS, where the request message carries indication information indicating that the gateway device uses a charging session granularity of an IP-CAN session, and receiving, by the gateway device, a session setup success message returned by the OCS.

An OCS (including an OCS function) provided in another embodiment of the present disclosure also includes a hardware architecture similar to that in FIG. 7. The OCS may be an OCS 402 in FIG. 4, and may be configured to perform the steps in all the foregoing method embodiments. A memory 806 stores a program 8062, and the program 8062 may be executed by a processor 802. This program includes receiving, by the OCS, a session setup request message sent by a gateway device, where the request message carries indication information indicating that the gateway device supports a charging session granularity of an IP-CAN session, and processing, by the OCS, the session setup request message according to the indication information and according to the charging session granularity of an IP-CAN session, and adding, to a response message to be returned to the gateway device, indication information indicating that the OCS performs charging according to the charging session granularity of an IP-CAN session.

Alternatively, this program includes receiving, by the OCS, a session setup request message sent by a gateway device, where the request message carries indication information indicating that the gateway device uses a charging session granularity of an IP-CAN session, and returning, by the OCS, a session setup success message to the gateway device.

It may be learned from the foregoing solutions provided in the embodiments of the present disclosure that, if the OCS may simultaneously support two charging session granularities, when setting up a charging session, the gateway device and the OCS negotiate a session granularity, and set up the charging session between the gateway device and the OCS according to the negotiated granularity, thereby avoiding inconsistent processing of charging information in the case of two granularities, and improving charging accuracy and charging efficiency.

Specific embodiments are used in this specification to describe the principle and implementations of the present disclosure. The foregoing embodiments are merely intended to help understand the method and idea of the present disclosure. In addition, with respect to the implementations and the application scope, modifications may be made by a person of ordinary skill in the art according to the idea of the present disclosure. Therefore, the specification shall not be construed as a limitation on the present disclosure.

1. A data service charging method, comprising:
sending, by a gateway device, a charging session setup request of an Internet Protocol-connectivity access network (IP-CAN) bearer to an online charging system, the charging session setup request carrying indication information indicating that the gateway device supports a charging session granularity of an IP-CAN session; and
receiving, by the gateway device, a response message from the online charging system according to the charging session setup request.

2. The method of claim 1, wherein the charging session setup request comprises a credit control request (CCR) initial (CCR-I) message, and the response message comprising a credit control answer (CCA) initial (CCA-I) message carrying indication information indicating that the online charging system performs charging according to the charging session granularity of the IP-CAN session.

3. The method of claim 1, further comprising sending, by the gateway device, a plurality of charging session setup requests to the online charging system, and before sending the charging session setup requests, the method further comprising adding, by the gateway device, to all the charging session setup requests, the indication information indicating that the gateway device supports the charging session granularity of the IP-CAN session.

4. The method of claim 1, further comprising sending, by the gateway device, a plurality of charging session setup requests to the online charging system, and before sending the charging session setup requests, the method further comprising adding, by the gateway device, only to a first or default charging session setup request, the indication information indicating that the gateway device supports the charging session granularity of the IP-CAN session.

5. The method of claim 1, further comprising sending, by the gateway device, one charging session setup request to the online charging system, before sending the one charging session setup requests, the method further comprising adding, by the gateway device, to the one charging session setup request, the indication information indicating that the gateway device supports the charging session granularity of the IP-CAN session, and the method further comprising sending, by the gateway device to the online charging system, a charging session setup request corresponding to another bearer after receiving the response message of the charging session setup request from the charging system not carrying indication information indicating that the online charging session granularity comprises the IP-CAN session.

6. The method of claim 2, further comprising:
sending, by the gateway device to the online charging system, a first CCR-I message carrying the indication information indicating that the gateway device supports the charging session granularity of the IP-CAN session;
receiving, by the gateway device, a CCA-I message from the charging system corresponding to the first CCR-I message carrying the indication information indicating that the online charging session granularity comprises the IP-CAN session; and
performing, by the gateway device, charging process for data streams on all bearers of the IP-CAN session in an online charging session.

7. A data service charging method, comprising:
sending, by a gateway device, charging information comprising a charging session granularity to an offline charging system; and
processing, by the offline charging system, the charging information according to the charging session granularity.

8. The method of claim 7, wherein sending the charging information comprises sending, by the gateway device, the charging information to the offline charging system using an accounting request (ACR) message, the ACR message comprising indication information, and the indication information indicating that the reported charging information comprises Internet Protocol-connectivity access network (IP-CAN) session granularity charging information or IP-CAN bearer granularity charging information.

9. The method of claim 8, further comprising generating, by the offline charging system, charging data record (CDR) information according to the ACR message after receiving the ACR message from the gateway device, and the CDR information comprising indication information of the charging session granularity.

10. The method of claim 7, wherein the charging information comprises charging data record (CDR) information, and the method further comprising:
generating, by the gateway device, the CDR information; and
sending, by the gateway device, the CDR information to the offline charging system, the CDR information comprising indication information indicating that the reported charging information comprises Internet Protocol-connectivity access network (IP-CAN) session granularity charging information or IP-CAN bearer granularity charging information.

11. The method of claim 8, further comprising processing, by the offline charging system, the charging information according to the charging session granularity comprising the IP-CAN bearer granularity when the indication information is empty.

12. The method of claim 10, further comprising processing, by the offline charging system, the charging information according to the charging session granularity comprising the IP-CAN bearer granularity when the indication information is empty.

13. The method of claim 8, further comprising determining, by the gateway device, according to a configuration of the gateway device or according to an instruction of a policy and charging rules function (PCRF) in a home domain or visited domain, that the charging information sent to the offline charging system comprises the charging session granularity.

14. The method of claim 11, further comprising determining, by the gateway device, according to a configuration of the gateway device or according to an instruction of a policy and charging rules function (PCRF) in a home domain or visited domain, that the charging information sent to the offline charging system comprises the charging session granularity.

15. A data service charging system, comprising:
a gateway device configured to report charging information comprising a charging granularity of the gateway device to an offline charging system, the charging granularity comprising an Internet Protocol-connectivity access network (IP-CAN) session charging granularity, and
the offline charging system coupled to the gateway device and configured to process the charging information from the gateway device.

16. The data service charging system of claim 15, wherein the gateway device is further configured to report the charging information to the offline charging system using an accounting request (ACR) message, the ACR message comprising indication information indicating that the reported charging information comprises IP-CAN session granularity charging information or IP-CAN bearer granularity charging information.

17. The data service charging system of claim 16, wherein after receiving the ACR message from the gateway device, the offline charging system is further configured to generate charging data record (CDR) information according to the ACR message, and the CDR information comprising indication information of the charging granularity.

18. The data service charging system of claim 15, wherein the charging information comprises charging data record (CDR) information, and the gateway device being further configured to:
generate the CDR information; and
send the CDR information to the offline charging system, the CDR information comprising indication information, and the indication information indicating that the reported charging information comprises IP-CAN session granularity charging information or IP-CAN bearer granularity charging information.

19. The data service charging system of claim 15, wherein the gateway device is further configured to determine, according to a configuration of the gateway device or according to an instruction of a policy and charging rules function (PCRF) in a home domain or visited domain, that the charging information sent to the offline charging system comprises the charging granularity.

20. The method of claim 1, further comprising sending, by the gateway device, one charging session setup request to the online charging system, before sending the one charging session setup requests, the method further comprising adding, by the gateway device to the one charging session setup request, the indication information indicating that the gateway device supports the charging session granularity of the IP-CAN session, and the method further comprising resending, by the gateway device, a charging session setup request corresponding to all bearers to the charging system after receiving the response message of the charging session setup request from the charging system indicating that charging session setup fails.
